(19) United States
(12) Patent Application Publication
(10) Pub. No.: US 2008/0038637 A1
(43) Pub. Date: Feb. 14, 2008

(54) Non-aqueous electrolyte secondary battery

(76) Inventors: Hiroshi Minami, Osaka (JP); Naoki Imachi, Osaka (JP)

Correspondence Address: KUBOVCIK & KUBOVCIK, SUITE 710, 900 17TH STREET NW, WASHINGTON, DC, 20006, US

(21) Appl. No.: 11/889,445

(22) Filed: Aug. 13, 2007

(30) Foreign Application Priority Data
Aug. 14, 2006 (JP) 2006-220799

(51) Int. Cl. H01M 4/52; H01M 4/62

(52) U.S. Cl. 429/231.3; 429/232

(57) ABSTRACT

A non-aqueous electrolyte secondary battery includes a positive electrode (11), a negative electrode (12), a separator (13), and a non-aqueous electrolyte solution. The positive electrode (11) contains a positive electrode active material (1), a conductive agent, and a binder. In the positive electrode, the positive electrode active material is not entirely coated with the conductive agent, and the separator satisfies the condition x·y≦1500 (μm·%), where x is the thickness (μm) and y is the porosity (%) of the separator. The non-aqueous electrolyte solution contains LiBF₄. The positive electrode is charged to 4.40 V or higher versus a lithium reference electrode potential.

### BACKGROUND OF THE INVENTION

1. Field of the Invention

The present invention relates to a non-aqueous electrolyte secondary battery comprising a positive electrode, a negative electrode, a separator, and a non-aqueous electrolyte solution, the positive electrode containing a positive electrode active material, a conductive agent, and a binder. More particularly, a feature of the invention is that the non-aqueous electrolyte secondary battery has a high capacity and is capable of excellent storage performance even under high temperature conditions.

2. Description of Related Art

Non-aqueous electrolyte secondary batteries have been widely used as new types of high power, high energy density secondary batteries for various appliances. A non-aqueous electrolyte secondary battery typically uses a non-aqueous electrolyte and performs charge-discharge operations by transferring lithium ions between the positive and negative electrodes.

Significant size and weight reductions in mobile electronic devices such as mobile telephones, notebook computers, and PDAs have been achieved in recent years. In addition, power consumption of such devices has been increasing as the number of functions of the devices has increased. This has led to a demand; for non-aqueous electrolyte secondary batteries with higher capacity and higher performance as the drive power source for such mobile information terminal devices.

Possible techniques to increase the capacity of the non-aqueous electrolyte secondary batteries include improving the performance of the active materials used in the positive electrode and the negative electrode, in addition to reducing the thickness of the battery can, the separator, and the current collectors used in the electrodes, which are not involved in the power-generating element.

In the non-aqueous electrolyte secondary batteries such as described above, a lithium-transition metal composite oxide, such as lithium-cobalt composite oxide and lithium-manganese composite oxide, is widely used as the positive electrode active material in the positive electrode.

Among the lithium-transition metal oxides, lithium cobalt, oxide (LiCoO₂), which is a lithium-cobalt composite oxide, has a theoretical capacity of about 273 mAh/g. In the non-aqueous electrolyte secondary battery that employs this type of positive electrode active material, the end-of-charge voltage is usually set at 4.2 V. In this case, the capacity of the lithium cobalt oxide is used only up to about 160 mAh/g.

In view of this, it is considered possible to increase the usable capacity of the lithium cobalt oxide in a non-aqueous electrolyte secondary battery that employs this positive electrode active material as described above by raising the end-of-charge voltage. For example, if the end-of-charge voltage is raised to 4.4 V, the capacity of the lithium cobalt oxide is used to about 200 mAh/g, which means that about a 10% increase in the capacity of the battery as a whole can be accomplished.

Nevertheless, the following problem arises with raising the end-of-charge voltage in a non-aqueous electrolyte secondary battery that uses lithium cobalt oxide or the like as the positive, electrode active material. When the end-of-charge voltage is increased, the oxidizing power of the charged positive electrode active material becomes higher, accelerating the decomposition of the non-aqueous electrolyte solution due to its contacting with the positive electrode active material. At the same time, the stability of the crystal structure of the positive electrode active material lowers. For example, in the case of lithium cobalt oxide, it has been known that the crystal structure tends to disintegrate easily when the positive electrode is charged to 4.40 V or higher versus the lithium reference electrode potential (see, for example, T. Ozuku et al., J. Electrochem. Soc. Vol. 141, (1994) p. 2972). This leads to considerable deterioration in the cycle performance and the storage performance of the battery.

In recent years, several proposals have been made to prevent the crystal structure of the positive electrode active material from disintegrating even when the end-of-charge voltage is raised. Examples include a battery that employs a positive electrode active material in which boron is contained in a layered lithium-transition metal composite oxide containing Ni and Mn (see, for example, Japanese Published Unexamined Patent Application No. 2004-281158), and a battery that employs a positive electrode active material in which a group IVA element of the periodic table, such as Zr, and a group IIA element of the periodic table, such as Mg, are contained in a layered lithium-transition metal composite oxide containing Li and Co (see, for example, Japanese Published Unexamined Patent Application No. 2005-50779).

Even with the non-aqueous electrolyte secondary batteries that employ the above-described positive electrode active materials, a problem arises that when the end-of-charge voltage is set high and the non-aqueous electrolyte secondary battery is used under a high temperature environment, Co or Mn is dissolved away from the positive electrode active material and is deposited on the negative electrode or the separator. As a consequence, the internal resistance of the battery increases and the capacity, deteriorates considerably.

### BRIEF SUMMARY OF THE INVENTION

It is an object of the present invention to resolve the foregoing and other problems of non-aqueous electrolyte secondary batteries. In particular, it is an object of the present invention to improve non-aqueous electrolyte secondary batteries comprising a negative electrode, a separator, a non-aqueous electrolyte solution, and a positive electrode containing a positive electrode active material, a conductive agent, and a binder so that the non-aqueous electrolyte secondary batteries can obtain a high capacity and excellent storage performance even under high temperature conditions.

In order to accomplish the foregoing and other objects, the present invention provides a non-aqueous electrolyte secondary battery comprising: a positive electrode containing a positive electrode active material, a conductive agent, and a binder, the positive electrode active material comprising positive electrode active material particles, the surface of each particle not entirely coated with the conductive agent, and the positive electrode having an end-of-charge voltage of 4.40 V or higher versus a lithium reference electrode potential; a negative electrode; a separator satisfying the condition x·y≦1500 (μm·%), where x is the thickness (μm) of the separator and y is the porosity (%) of the separator; and a non-aqueous electrolyte solution containing LiBF₄.

In the non-aqueous electrolyte secondary battery of the present invention, because the positive electrode is charged to 4.40 V or higher versus a lithium reference electrode potential as described above, the capacity of the non-aqueous electrolyte secondary battery can be increased. At the same time, since the non-aqueous electrolyte secondary battery employs the non-aqueous electrolyte solution containing LiBF₄, the LiBF₄ added to the non-aqueous electrolyte solution serves to form a surface film on the surface of the positive electrode active material, and as a result, it becomes possible to inhibit the non-aqueous electrolyte solution from directly coming into contact with the positive electrode active material even in the case of using the positive electrode in which the surface of each positive electrode active material particle is not entirely coated with the conductive agent.

As a result, in the non-aqueous electrolyte secondary battery of the present invention, the non-aqueous electrolyte solution can be prevented from coming into contact with the positive electrode active material and from being decomposed, and the crystal structure of the positive electrode active material can be inhibited from disintegrating even when the positive electrode is charged to 4.40 V or higher versus a lithium reference electrode potential to increase the capacity. Thus, it becomes possible to obtain a non-aqueous electrolyte secondary battery with a high capacity and excellent storage performance even under high temperature conditions.

### BRIEF DESCRIPTION OF THE DRAWINGS

FIG. 1 is a schematic illustrative drawing showing the condition of a positive electrode active material obtained without dry-blending a positive electrode active material and a conductive agent when preparing a positive electrode used for a non-aqueous electrolyte secondary battery of the present invention;

FIG. 2 is a schematic illustrative drawing showing the condition of a positive electrode active material obtained by dry-blending a positive electrode active material and a conductive agent when preparing a positive electrode;

FIGS. 3(A) and 3(B) are a schematic perspective view and a partial cross-sectional view, respectively, illustrating a flat electrode assembly fabricated in Examples and Comparative Examples of the present invention;

FIG. 4 is a schematic plan view illustrating a non-aqueous electrolyte secondary battery, fabricated in Examples and Comparative Examples of the present invention; and

FIG. 5 is a graph illustrating the relationship between separator pore volume x·y and capacity retention rate after high temperature storage, for non-aqueous electrolyte secondary batteries of Examples 2, 9, and 10 and Comparative Examples 1 and 13 to 16, which have varied separator pore volumes x·y.

### DETAILED DESCRIPTION OF THE INVENTION

Herein below, preferred embodiments of the non-aqueous electrolyte secondary battery according to the present invention are described in detail. It should be construed, however, that the non-aqueous electrolyte secondary battery according to the present invention is not limited to the following preferred embodiments and various changes and modifications are possible without departing from the scope of the invention.

The non-aqueous electrolyte secondary battery according to the present invention comprises: a positive electrode containing a positive electrode active material, a conductive agent, and a binder, the positive electrode active material comprising positive electrode active material particles, the surface of each particle not entirely coated with the conductive agent, and the positive electrode having an end-of-charge voltage of 4.40 V or higher versus a lithium reference electrode potential; a negative electrode; a separator satisfying the condition x·y≦1500 (μm·%), where x is the thickness (μm) of the separator and y is the porosity (%) of the separator; and a non-aqueous electrolyte, solution containing LiBF₄. In order to further increase the capacity of the non-aqueous electrolyte secondary battery, it is preferable that the positive electrode be charged to 4.45 V or higher, or more preferably to 4.50 V or higher, versus a lithium reference electrode potential.

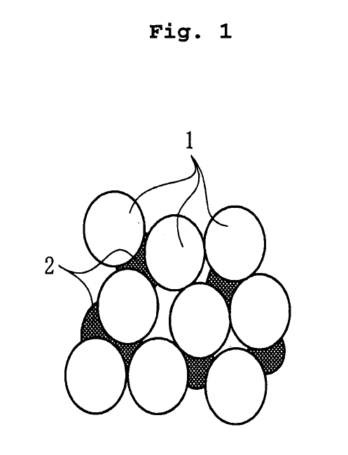

Here, when the positive electrode active material, the conductive agent, and the binder are wet-blended to prepare the positive electrode comprising the positive electrode active material, the conductive agent, and the binder as described above, a mixture 2 of the conductive agent and the binder is interspersed between adjacent positive electrode active material particles 1, as illustrated in FIG. 1. Thus, the positive electrode active material particles 1 are not entirely coated with the mixture 2, and in the portions wherein the mixture 2 do not exist, the non-aqueous electrolyte solution is allowed to directly come into contact with the positive electrode active material particles 1. The range of percentage of the surface of the positive electrode active material particles that is coated with the conductive agent is preferably less than 99%, or more preferably less than 90%, or more preferably less than 60%.

However, when using the non-aqueous electrolyte solution containing LiBF₄ as described above, the LiBF₄ added to the non-aqueous electrolyte solution forms a surface film on the positive electrode active material surface that is not coated with the conductive agent and the like, so the entire surface of the positive electrode active material is covered therewith. This inhibits the non-aqueous electrolyte solution from being directly in contact with the positive electrode active material. As a result, even when the positive electrode is charged to 4.40 V or higher versus a lithium reference electrode potential and the non-aqueous electrolyte secondary battery is used under a high temperature condition of 50° C. or higher, the non-aqueous electrolyte solution is inhibited from coming into contact with the positive electrode active material and from decomposing.

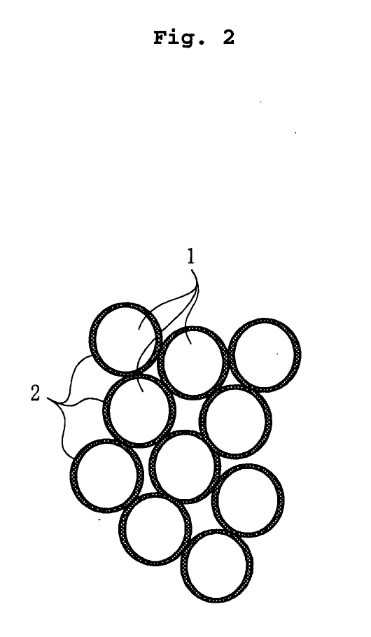

It should be noted that when the coated positive electrode active material is wet-blended with the binder after the conductive agent is coated on the surface of the positive electrode active material by dry-blending using a roller mill, a ball mill, a mechanofusion system, a jet mill, or the like, the entire surface of each positive electrode active material particle 1 is coated with the mixture 2 of the conductive agent and the binder, as illustrated in FIG. 2, whereby the non-aqueous electrolyte solution is inhibited from directly coming into contact with the positive electrode active material particles 1. However, when the entire surface of each positive electrode active material particle 1 is coated with the mixture 2 of the conductive agent and the binder, no surface film originating from LiBF₄ is formed on the surface of each of the positive electrode active material particles 1 even in the case of using the above-described non-aqueous electrolyte solution containing LiBF₄, and the use of LiBF₄ yields no advantageous effect.

The positive electrode active material may be any commonly used lithium-transition metal composite oxide, such as lithium-cobalt composite oxide, lithium-manganese composite oxide, lithium-cobalt-nickel-manganese composite oxide, lithium-cobalt-nickel-aluminum composite oxide, and lithium-manganese-nickel-aluminum composite oxide. It is preferable to use a lithium-transition metal composite oxide that can attain a high voltage and increase the capacity. For example, a lithium-cobalt composite oxide such as lithium cobalt oxide is preferable.

In the case that the positive electrode active material is lithium cobalt oxide, the stability of the crystal structure deteriorates if the positive electrode is charged to 4.40 V or higher versus a lithium reference electrode potential. For this reason, it is preferable that at least Al and/or Mg be contained in the lithium cobalt oxide in the form of a solid solution and also Zr be adhered to the surface thereof.

Here, when the lithium cobalt oxide contains Al and/or Mg in the form of a solid solution, the crystal structure of the lithium cobalt oxide becomes stable. Although both Al and Mg have almost the same effect in terms of stabilizing the crystal structure, it is preferable that the lithium cobalt oxide contain Mg in the form of a solid solution in order to lessen the deterioration in the initial charge-discharge efficiency and the discharge working voltage. The amount of Al and/or Mg that can be contained in the lithium cobalt oxide should be 0.5 mole % or more and 3 mole % or less. The charge-discharge property becomes worse if the amount is more than 3 mole % and the effect of the invention is negligible if the amount is less than 0.5 mole %.

When the lithium cobalt oxide contains Al or Mg in the form of a solid solution, there is a risk that the discharge working voltage may degrade. However, when Zr is adhered on the surface of the lithium cobalt oxide as described above, the interface charge transfer resistance, which is the resistance at the interface between the lithium cobalt oxide and the non-aqueous electrolyte solution, reduces significantly, and the discharge working voltage improves greatly. It should be noted that the discharge working voltage improves significantly when a tetravalent or pentavalent element such as Sn, Ti, or Nb is added other than Zr. Nevertheless, when Sn, Ti, Nb, and the like is used other than Zr, the crystal growth of the lithium cobalt oxide is hindered in sintering, and the safety of the lithium cobalt oxide itself tends to reduce. Therefore, it is preferable to use Zr. The amount of Zr to Co and Zr should be 0.1 mole % or more and 1 mole % or less. The area covered with Zr increases and the discharge property becomes worse if the amount is more than 1 mole % and the effect of the invention is negligible if the amount is less than 0.1 mole %. Zr particle size is preferably between 100 nm and 3 μm. The area covered with Zr increases and the discharge property becomes worse if Zr particle size is less than 100 nm. Zr particles are not distributed equally and the effect of the invention is negligible if Zr particle size is more than 3 μm.

The non-aqueous electrolyte solution may be a non-aqueous electrolyte solution in which LiBF₄ alone as a solute or a mixture of LiBF₄ and another solute is added to a non-aqueous solvent.

When adding LiBF₄ to the non-aqueous electrolyte solution, the surface film may not be formed sufficiently on the surface of the positive electrode active material if the amount of LiBF₄ added is too small. On the other hand, the discharge capacity and the discharge load characteristics of the non-aqueous electrolyte secondary battery will degrade due to side reactions originating from LiBF₄ if the amount of LiBF₄ added is too large. For this reason, it is preferable that LiBF₄ added to the non-aqueous electrolyte solution within the range of from 0.1 weight % to 5.0 weight %.

The other solute that is added along with LiBF₄ may be any known commonly-used solute. Examples include LiPF₆, LiCF₃SO₃, LiN(CF₃SO₂)₂, LiN(C₂F₅SO₂)₂, and LiPF₆₋ₓ(CₙF₂ₙ₊₁)ₓ where 1<x<6 and n=1 or 2. It is especially preferable that LiPF₆ be added in an amount of from 0.6 mol/L to 2.0 mol/L.

The non-aqueous solvent may be any known commonly-used non-aqueous solvent. Examples include cyclic carbonates such as ethylene carbonate, propylene carbonate, and butylene carbonate, and chain carbonates such as dimethyl carbonate, methyl ethyl carbonate, and diethyl carbonate.

It is preferable that the non-aqueous electrolyte solution further contain a surface-film forming agent for forming a surface film on the negative electrode. The addition of the surface-film forming agent to the non-aqueous electrolyte solution allows a surface film originating from the surface-film forming agent to form on the negative electrode surface. This prevents decomposition of LiBF₄ on the negative electrode surface while at the same time the LiBF₄ forms a thick film on the negative electrode surface, preventing deterioration of the initial capacity.

Examples of the just-described surface-film forming agent include vinylene carbonate (VC) and vinyl ethylene carbonate (VEC). It is also possible that CO₂ be dissolved in the non-aqueous electrolyte solution. When vinylene carbonate (VC) or vinyl ethylene carbonate (VEC) is added to the non-aqueous electrolyte solution as the surface-film forming agent, it is preferable that the surface-film forming agent be added in an amount of from 0.1 weight % to 5.0 weight % to the non-aqueous electrolyte solution.

It is preferable to use a separator having a pore volume of 1500 μm·% or less, and more preferably 800 μm·% or less, the pore volume being expressed as x·y, where x is the separator thickness (μm), and y is the separator porosity (%). The pore size of the separator is preferably between 0.1 μm and 1 μm.

Generally, the separator needs to withstand the process steps for fabricating the battery, in addition to ensuring insulation within the battery. When the film thickness of the separator is reduced, the strength of the separator accordingly lowers, although the energy density of the battery improves, so it becomes necessary to reduce the average pore size or to decrease the porosity of the pores provided in the separator. On the other hand, when the film thickness of the separator is made thick, the strength of the separator can be ensured to a certain extent, so the average pore size and porosity of the pores provided in the separator may be selected relatively freely, although the energy density of the battery decreases.

For this reason, it is preferable that the film thickness of the separator be set at a certain thickness, generally at about 20 μm, and that the average pore size and porosity of the pores in the separator be adjusted.

The use of the separator having such a pore volume, expressed as x·y, as described above makes it possible to prevent the energy density of the battery from decreasing. It also inhibits the considerable deterioration of the separator performance that is caused by clogging of the separator resulting from the decomposed products of the non-aqueous electrolyte solution and the substances that have dissolved away from the positive electrode active material. It also inhibits the substances that have dissolved away from the positive electrode active material from migrating to the negative electrode through the separator.

In the non-aqueous electrolyte secondary battery of the present invention, the negative electrode active material used for the negative electrode may be any known commonly-used negative electrode active material, as long as the negative electrode active material is capable of intercalating and deintercalating lithium ions. Examples include carbon materials such as graphite and coke, as well as tin oxide, metallic lithium, silicon, and mixtures thereof.

### EXAMPLES

Herein below, examples of the non-aqueous electrolyte secondary battery according to the present invention will be described in detail along with comparative examples, and it will be demonstrated that the examples of the non-aqueous electrolyte secondary battery according to the present invention are capable of inhibiting deterioration in storage performance at high temperatures even when the positive electrode is charged to 4.40 V or higher to increase the capacity.

### Example 1

In Example 1, a non-aqueous electrolyte secondary battery was fabricated using a positive electrode, a negative electrode, a separator, and a non-aqueous electrolyte that were prepared in the following manner.

### Positive Electrode

The positive electrode was prepared as follows. Lithium cobalt oxide (LiCoO₂) containing 1.0 of Al and 1.0 of Mg in the form of a solid solution and 0.05 of Zr adhering to the surface thereof was used as the positive electrode active material.

The positive electrode active material was mixed with acetylene black serving as a conductive agent and polyvinylidene fluoride serving as a binder at a mass ratio of 95:2.5:2.5, and a diluting solvent N-methyl-2-pyrrolidone was added thereto. The mixture was kneaded using a Combimix mixer made by Tokushu Kika Kogyo Co., Ltd. to thus prepare a positive electrode mixture slurry. The resultant positive electrode mixture slurry was applied onto both sides of a positive electrode current collector made of aluminum foil, then dried, and thereafter pressure-rolled to prepare a positive electrode. A cross section of the positive electrode prepared in the above-described manner was observed with a SEM photograph. As a result, it was found that, as shown in FIG. 1, the mixture of the conductive agent and the binder was interspersed between the positive electrode active material particles, and that the surface of each positive electrode active material particle was partially coated with the conductive agent and so forth. The filling density of the positive electrode was 3.60 g/cm³.

### Negative Electrode

The negative electrode was prepared as follows. Graphite as a negative electrode material, carboxymethylcellulose sodium, and styrene-butadiene rubber were mixed in an aqueous solution at a mass ratio of 98:1:1. The resultant mixture was applied onto both sides of a copper foil, then dried, and thereafter pressure-rolled, to prepare the negative electrode. The filling density of the negative electrode active material in the negative electrode was 1.60 g/cm³.

### Non-aqueous Electrolyte Solution

The non-aqueous electrolyte solution was prepared as follows. Lithium hexafluorophosphate (LiPF₆) as a solute was dissolved at a concentration of 1 mol/L into a mixed solvent of 3:7 volume ratio of ethylene carbonate, which is a cyclic carbonate, and diethyl carbonate, which is a chain carbonate, and LiBF₄ was added thereto in an amount of 1.0 weight %.

### Separator

The separator used was a microporous polypropylene film having a thickness x of 16 μm, a porosity y of 47%, and a pore volume x·y of 752 μm·%.

### Preparation of Battery

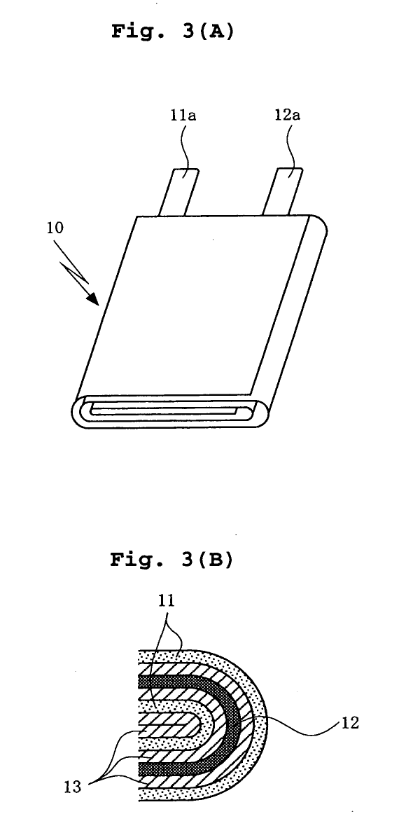

A battery was prepared in the following manner. As illustrated in FIGS. 3(A) and 3(B), a positive electrode lead 11a and a negative electrode lead 12a were respectively attached to a positive electrode 11 and a negative electrode 12 prepared in the above-described manner. Then, the positive electrode 11 and the negative electrode 12 were wound together with a separator 13 as mentioned above so that the separator 13 was interposed between the positive electrode 11 and the negative electrode 12, and the electrodes with the separator were pressed to prepare a flat electrode assembly 10.

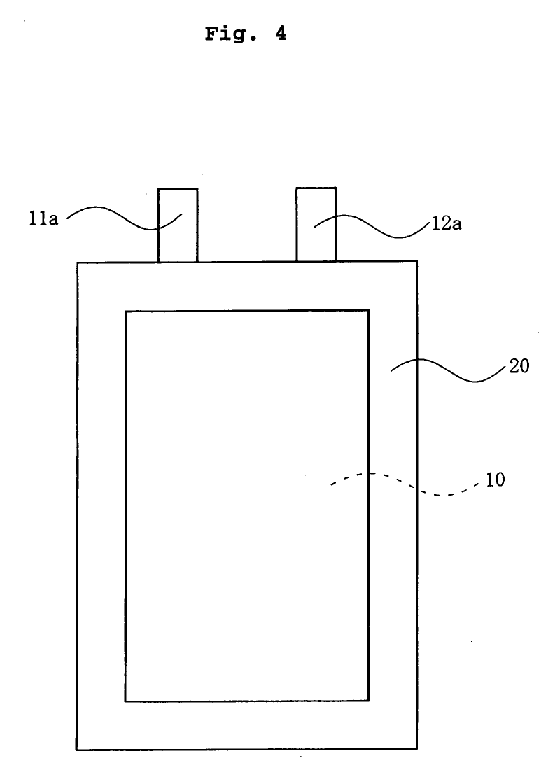

Next, as illustrated in FIG. 4, the just-described flat electrode assembly 10 was put into a battery case 20 made of an aluminum laminate film, and the foregoing non-aqueous electrolyte solution was filled into the battery case 20. Thereafter, the opening of the battery case 20 was sealed in such a manner that the positive electrode lead 11a and the negative electrode lead 12a were led outside, to thus prepare a non-aqueous electrolyte secondary battery having a design capacity of 780 mAh.

In this Example 1, the non-aqueous electrolyte secondary battery was designed so that the end-of-charge voltage was 4.40 V (which is equivalent to 4.50 V versus a lithium reference electrode potential [vs. Li/Li⁺]) and that the ratio of the negative electrode capacity to the positive electrode capacity at that potential was 1.08.

### Example 2

In Example 2, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1, except that the non-aqueous electrolyte solution contained LiBF₄ in an amount of 3.0 weight %.

### Example 3

In Example 3, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1, except that the non-aqueous electrolyte solution contained LiBF₄ in an amount of 5.0 weight %.

### Comparative Example 1

In Comparative Example 1, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1, except that no LiBF₄ was added to the non-aqueous electrolyte solution.

Next, each of the non-aqueous electrolyte secondary batteries of Examples 1 to 3 and Comparative Example 1 was charged at a current of 750 mA to an end-of-charge voltage of 4.40 V, and was further charged at a constant voltage of 4.40 V until the current value reached 37.5 mA, and the initial charge capacity Qx of each of the non-aqueous electrolyte secondary batteries was obtained. Then, each of the non-aqueous electrolyte secondary batteries was rested for 10 minutes and thereafter was discharged at a constant current of 750 mA until the battery voltage lowered to 2.75 V, and the corresponding discharge capacity Qo of each of the non-aqueous electrolyte secondary batteries was measured.

Also, under a room temperature condition, each of the non-aqueous electrolyte secondary batteries was charged at a constant current of 750 mA to an end-of-charge voltage of 4.40 V and thereafter charged at a constant voltage of 4.40 V until the current value reached 37.5 mA. Then, each battery was set aside for 5 days under a high temperature condition of 60° C. Thereafter, each of the non-aqueous electrolyte secondary batteries was discharged at a constant current of 750 mA until the battery voltage lowered to 2.75 V, and the remaining discharge capacity Qa for each of the non-aqueous electrolyte secondary batteries was measured. Then, the capacity retention rate (%) after high temperature storage was obtained for each of the non-aqueous electrolyte secondary batteries, according to the following equation. The results are shown in Table 1 below.

Capacity retention rate after storage (%)=(Qa/Qo)×100.

TABLE 1

| | | Non- | | | | | |
|---|---|---|---|---|---|---|---|
| | | aqueous | | | Designed | | |
| | | electrolyte | | Sepa- | end-of- | | Capacity |
| | | solution | | rator | charge | | retention |
| | Positive | LiPF₆ | | x · y | voltage | | rate after |
| | electrode | (mol/ | LiBF₄ | (μm · | | (V vs. | storage |
| | condition | L) | (wt. %) | %) | (V) | Li/Li⁺) | (%) |
| Ex. 1 | FIG. 1 | 1 | 1 | 752 | 4.40 | 4.50 | 61.3 |
| Ex. 2 | FIG. 1 | 1 | 3 | 752 | 4.40 | 4.50 | 72.0 |
| Ex. 3 | FIG. 1 | 1 | 5 | 752 | 4.40 | 4.50 | 72.5 |
| Comp. | FIG. 1 | 1 | — | 752 | 4.40 | 4.50 | 16.4 |
| Ex. 1 | | | | | | | |

The results demonstrate that each of the non-aqueous electrolyte secondary batteries of Examples 1 to 3 exhibited a significant improvement in capacity retention rate after high temperature storage over the non-aqueous electrolyte secondary battery of Comparative Example 1, in the case that each of the batteries used the positive electrode in which the mixture of the conductive agent and the binder was interspersed between the positive electrode active material particles and the surface of each positive electrode active material particle was not entirely coated with the conductive agent and the like. Note that each of the non-aqueous electrolyte secondary batteries of Examples 1 to 3 used a non-aqueous electrolyte solution containing LiBF₄, whereas the non-aqueous electrolyte secondary battery of Comparative Example 1 used a non-aqueous electrolyte solution that does not contain LiBF₄.

When comparing the non-aqueous electrolyte secondary batteries of Examples 1 to 3, it is demonstrated that the greater the amount of LiBF₄ added to the non-aqueous electrolyte solution, the better the capacity retention rate after high temperature storage.

### Example 4

In Example 4, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1, except that the non-aqueous electrolyte solution was prepared by dissolving, as the solutes, lithium hexafluorophosphate (LiPF₆) at a concentration of 0.9 mol/L as well as LiBF₄ at a concentration of 0.1 mol/L in the above-described mixed solvent. It should be noted that in the just-described non-aqueous electrolyte solution, the amount of LiBF₄ added to the non-aqueous electrolyte solution is about 1.0 weight %.

### Example 5

In Example 5, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1, except that the non-aqueous electrolyte solution was prepared by dissolving, as the solutes, lithium hexafluorophosphate (LiPF₆) at a concentration of 0.5 mol/L as well as LiBF₄ at a concentration of 0.5 mol/L in the above-described mixed solvent. It should be noted that in the just-described non-aqueous electrolyte solution, the amount of LiBF₄ added to the non-aqueous electrolyte solution is about 5.0 weight %.

In the same way as for the non-aqueous electrolyte secondary batteries of Example 1 and Comparative Example 1, the capacity retention rate (%) after high temperature storage was obtained for each of the non-aqueous electrolyte secondary batteries of Examples 4 and 5, which were fabricated in the above-described manners. In addition, the initial charge-discharge efficiency (%) for each of the non-aqueous electrolyte secondary batteries of Examples 1, 4, and 5 as well as Comparative Example 1 was obtained from the initial charge capacity Qx and the corresponding discharge capacity Qo, using the following equation. The results are shown in Table 2 below.

Initial charge-discharge efficiency (%)=(Qo/Qx)×100

TABLE 2

| | | | | | | | Capacity | |
|---|---|---|---|---|---|---|---|---|
| | | Non-aqueous | | | | | retention | Initial |
| | | electrolyte | | | Designed | | rate | charge- |
| | Positive | solution | | Separator | end-of-charge | | after | discharge |
| | electrode | LiPF₆ | LiBF₄ | x · y | voltage | | storage | efficiency |
| | condition | (mol/L) | (wt. %) | (μm · %) | (V) | (V vs. Li/Li⁺) | (%) | (%) |
| Ex. 1 | FIG. 1 | 1 | 1 | 752 | 4.40 | 4.50 | 61.3 | 92.6 |
| Comp. | FIG. 1 | 1 | — | 752 | 4.40 | 4.50 | 16.4 | 92.7 |
| Ex. 1 | | | | | | | | |
| Ex. 4 | FIG. 1 | 0.9 | approx. 1 | 752 | 4.40 | 4.50 | 62.2 | 91.5 |
| Ex. 5 | FIG. 1 | 0.5 | approx. 5 | 752 | 4.40 | 4.50 | 77.5 | 90.5 |

The results demonstrate that, as well as the non-aqueous electrolyte secondary batteries of Examples 1 to 3, the non-aqueous electrolyte secondary batteries of Examples 4 and 5 exhibited significant improvements in the capacity retention rate after high temperature storage over the battery of Comparative Example 1, which used a non-aqueous electrolyte solution not containing LiBF₄.

When comparing the non-aqueous electrolyte secondary batteries of Examples 4 and 5, it is demonstrated that the greater the amount of LiBF₄ added to the non-aqueous electrolyte solution, the better the capacity retention rate after high temperature storage, as in the case of the non-aqueous electrolyte secondary batteries of Examples 1 to 3.

In addition, when comparing the non-aqueous electrolyte secondary batteries of Example 1, 4, and 5, the batteries of Examples 4 and 5, in which the total mole concentration of the solutes LiPF₆ and LiBF₄ in the non-aqueous electrolyte solution was 1 mol/L, showed lower initial charge-discharge efficiencies than the battery of Example 1, in which LiPF₆ was added at a concentration of 1 mol/L and LiBF₄ at a concentration of 1 weight % to the whole amount of the electrolyte, indicating that the lower the concentration of LiPF₆ in the non-aqueous electrolyte solution is, the lower the initial charge-discharge efficiency. This is believed to be because LiBF₄ in the non-aqueous electrolyte solution was consumed when forming the surface film, and consequently the concentration of the lithium salts reduced in the non-aqueous electrolyte solution, lowering the ionic conductivity of the non-aqueous electrolyte solution.

### Comparative Example 2

In Comparative Example 2, the positive electrode was prepared as follows. The positive electrode active material and the conductive agent as described in Example 1 were mixed at a mass ratio of 95:2.5, and the mixture was dry-blended with a mechanofusion system (made by Hosokawa Micron Corp.) at a rate of 1500 rpm for 10 minutes, to thereby coat the surface of the positive electrode active material with the conductive agent. Thereafter, the positive electrode active material coated with the conductive agent was mixed with the foregoing binder at a mass ratio of 97.5:2.5, and a diluting solvent N-methyl-2-pyrrolidone was added to the mixture. Thereafter, the positive electrode was prepared in the same manner as described in Example 1 above. A cross section of the positive electrode prepared in this manner was observed with an SEM photograph. As a result, it was found that, as shown in FIG. 2, the entire surface of each of the positive electrode active material particles was coated with a coating layer made of the mixture of the conductive agent and the binder.

Further, in Comparative Example 2, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1 above, except that the positive electrode prepared in the just-described manner was used, and that no LiBF₄ was added to the non-aqueous electrolyte solution as in the case of Comparative Example 1 above.

### Comparative Example 3

In Comparative Example 3, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1 above, except that the positive electrode prepared in the same manner as described in Comparative Example 2 above was used, and that the non-aqueous electrolyte solution contained lithium hexafluorophosphate (LiPF₆) at a concentration of 1 mol/L and LiBF₄ in an amount of 3.0 weight %, as in Example 2 above.

### Comparative Example 4

In Comparative Example 4, the positive electrode was prepared as follows. The positive electrode active material and the conductive agent as described in Example 1 were mixed at a mass ratio of 95:2.5, and the mixture was dry-blended with a Raikai motor for 30 minutes, to thereby coat the surface of the positive electrode active material with the conductive agent. Thereafter, the positive electrode active material coated with the conductive agent was mixed with the foregoing binder at a mass ratio of 97.5:2.5, and a diluting solvent N-methyl-2-pyrrolidone was added to the mixture. Thereafter, the positive electrode was prepared in the same manner as described in Example 1 above. A cross section of the positive electrode prepared in this manner was observed with an SEM photograph. As a result, it was found that, as shown in FIG. 2, the entire surface of each of the positive electrode active material particles was coated with a coating layer made of the mixture of the conductive agent and the binder.

Then, in Comparative Example 4, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1 above, except that the positive electrode prepared in the just-described manner was used, and that the non-aqueous electrolyte solution contained no LiBF₄, as in the case of Comparative Example 1 above.

### Comparative Example 5

In Comparative Example 5, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1 above, except that the positive electrode prepared in the same manner as described in Comparative Example 4 above was used, and that the non-aqueous electrolyte solution contained lithium hexafluorophosphate (LiPF₆) at a concentration of 1 mol/L and LiBF₄ in an amount of 3.0 weight %, as in Example 2 above.

The capacity retention rate (%) after high temperature storage was obtained for each of the non-aqueous electrolyte secondary batteries of Comparative Examples 2 to 5, in the same manner as in the cases of the non-aqueous electrolyte secondary batteries of Example 2 and Comparative Example 1 above. The results are shown in Table 3 below.

TABLE 3

| | | | | | | | Capacity | |
|---|---|---|---|---|---|---|---|---|
| | | Non-aqueous | | | | | retention | |
| | | electrolyte | | | Designed | | rate | |
| | Positive | solution | | | end-of-charge | | after | Dry-blending |
| | electrode | LiPF₆ | LiBF₄ | Separator | voltage | | storage | of positive |
| | condition | (mol/L) | (wt. %) | x · y (μm · %) | (V) | (V vs. Li/Li⁺) | (%) | electrode |
| Ex. 2 | FIG. 1 | 1 | 3 | 752 | 4.40 | 4.50 | 72.0 | — |
| Comp. | FIG. 1 | 1 | — | 752 | 4.40 | 4.50 | 16.4 | — |
| Ex. 1 | | | | | | | | |
| Comp. | FIG. 2 | 1 | — | 752 | 4.40 | 4.50 | 70.2 | Mechanofusion |
| Ex. 2 | | | | | | | | |
| Comp. | FIG. 2 | 1 | 3 | 752 | 4.40 | 4.50 | 71.1 | Mechanofusion |
| Ex. 3 | | | | | | | | |
| Comp. | FIG. 2 | 1 | — | 752 | 4.40 | 4.50 | 70.1 | Raikai |
| Ex. 4 | | | | | | | | |
| Comp. | FIG. 2 | 1 | 3 | 752 | 4.40 | 4.50 | 71.3 | Raikai |
| Ex. 5 | | | | | | | | |

The results demonstrate that each of the non-aqueous electrolyte secondary batteries of Comparative Examples 2 to 5 exhibited a significantly greater capacity retention rate after high temperature storage than the non-aqueous electrolyte secondary battery of Comparative Example 1. Note that each of the non-aqueous electrolyte secondary batteries of Comparative Examples 2 to 5 used positive electrode in which the entire surface of each positive electrode active material particle was coated with the coating layer made of the mixture of the conductive agent and the binder by dry-blending the positive electrode active material and the conductive agent, while the non-aqueous electrolyte secondary battery of Comparative Example 1 used a positive electrode in which a mixture of the conductive agent and the binder was interspersed, between the positive electrode active material particles and also the non-aqueous electrolyte solution contained no LiBF₄.

Nevertheless, among the non-aqueous electrolyte secondary batteries of Comparative Examples 2 to 5, the batteries of Comparative Examples 3 and 5 did not show noticeable improvements in the capacity retention rate after high temperature storage over the batteries of Comparative Examples 2 and 4. Note that the batteries of Comparative Examples 3 and 5 used the non-aqueous electrolyte solution containing LiBF₄ in an amount of 3.0 weight % while the batteries of Comparative Examples 2 and 4 used the non-aqueous electrolyte solution not containing LiBF₄. This is unlike the case between the battery of Example 2, which used the non-aqueous electrolyte solution containing LiBF₄ in an amount of 3.0 weight %, and the battery of Comparative Example 1, which used the non-aqueous electrolyte solution containing no LiBF₄. This means that the use of the non-aqueous electrolyte solution containing LiBF₄ had little advantageous effect on the capacity retention rate after storage in the batteries of Comparative Examples 2 to 5.

### Examples 6 and 7

In Examples 6 and 7, each of the batteries was fabricated in the same manner as described in Example 1 above, except that the non-aqueous electrolyte solution contained LiPF₆ at a concentration of 1 mol/L and LiBF₄ in an amount of 3.0 weight %, as in Example 2, above, and that the designed values of the end-of-charge voltage were varied.

In Example 6, the non-aqueous electrolyte secondary battery was designed so that the end-of-charge voltage was 4.35 V (which is equivalent to 4.45 V versus a lithium reference electrode potential [vs. Li/Li⁺]), and that the ratio of the negative electrode capacity to the positive electrode capacity at that potential was 1.08. In Example 7, the non-aqueous electrolyte secondary battery was designed so that the end-of-charge voltage was 4.30 V (which is equivalent to 4.40 V versus a lithium reference electrode potential [vs. Li/Li⁺]), and that the ratio of the negative electrode capacity to the positive electrode capacity at that potential was 1.08.

### Comparative Example 6

In Comparative Example 6 as well, a battery was fabricated in the same manner as described in Example 1 above, except that the non-aqueous electrolyte solution contained LiPF₆ at a concentration of 1 mol/L and LiBF₄ in an amount of 3.0 weight %, as in Example 2 above, and that the designed value of the end-of-charge voltage was changed.

In Comparative Example 6, the non-aqueous electrolyte secondary battery was designed so that the end-of-charge voltage was 4.20 V (which is equivalent to 4.30 V versus a lithium reference electrode potential [vs. Li/Li⁺]) and that the ratio of the negative electrode capacity to the positive electrode capacity at that potential was 1.08.

### Comparative Examples 7 to 9

In Comparative Examples 7 to 9, batteries were fabricated in the same manner as described in Example 1 above, except that the non-aqueous electrolyte solution contained no LiBF₄ as in Comparative Example 1 above, and that the designed values of the end-of-charge voltage were varied.

In Comparative Example 7, the non-aqueous electrolyte secondary battery was designed so that the end-of-charge voltage was 4.35 V (which is equivalent to 4.45 V versus a lithium reference electrode potential [vs. Li/Li⁺]), and that the ratio of the negative electrode capacity to the positive electrode capacity at that potential was 1.08. In Comparative Example 8, the non-aqueous electrolyte secondary battery was designed so that the end-of-charge voltage was 4.30 V (which is equivalent to 4.40 V versus a lithium reference electrode potential [vs. Li/Li⁺]), and that the ratio of the negative electrode capacity to the positive electrode capacity at that potential was 1.08. In Comparative Example 9, the non-aqueous electrolyte secondary battery was designed so that the end-of-charge voltage was 4.20 V (which is equivalent to 4.30 V versus a lithium reference electrode potential [vs. Li/Li⁺]), and that the ratio of the negative electrode capacity to the positive electrode capacity at that potential was 1.08.

### Comparative Example 10

In Comparative Example 10, the positive electrode was such that the surface of the positive electrode active material was coated with the conductive agent as in the case of Comparative Example 2 above, and the non-aqueous electrolyte solution contained no LiBF₄ as in the case of Comparative Example 1 above. Then, the battery was designed so that the end-of-charge voltage was 4.20 V (which is equivalent to 4.30 V versus a lithium reference electrode potential [vs. Li/Li⁺]) and that the ratio of the negative electrode capacity to the positive electrode capacity at that potential was 1.08.

### Comparative Example 11

In Comparative Example 11, the positive electrode was such that the surface of the positive electrode active material was coated with the conductive agent as in the case of Comparative Example 2 above, and the non-aqueous electrolyte solution contained LiPF₆ at a concentration of 1 mol/L and LiBF₄ in an amount of 3.0 weight %, as in Example 2 above. Then, the battery was designed so that the end-of-charge voltage was 4.20 V (which is equivalent to 4.30 V versus a lithium reference electrode potential [vs. Li/Li⁺]) and that the ratio of the negative electrode capacity to the positive electrode capacity at that potential was 1.08.

The capacity retention rate (%) after high temperature storage was obtained for each of the non-aqueous electrolyte secondary batteries of Examples 6 and 7 as well as Comparative Examples 6 to 11, in the same manner as in the cases of the non-aqueous electrolyte secondary batteries of Example 2 and Comparative Examples 1 to 3 above. The results are shown in Table 4 below.

TABLE 4

| | | Non-aqueous | | | | | Capacity | |
|---|---|---|---|---|---|---|---|---|
| | | electrolyte | | | Designed | | retention | |
| | Positive | solution | | Separator | end-of-charge | | rate after | Dry-blending |
| | electrode | LiPF₆ | LiBF₄ | x · y | voltage | | storage | of positive |
| | condition | (mol/L) | (wt. %) | (μm · %) | (V) | (V vs. Li/Li⁺) | (%) | electrode |
| Ex. 2 | FIG. 1 | 1 | 3 | 752 | 4.40 | 4.50 | 72.0 | — |
| Comp. Ex. 1 | FIG. 1 | 1 | — | 752 | 4.40 | 4.50 | 16.4 | — |
| Ex. 6 | FIG. 1 | 1 | 3 | 752 | 4.35 | 4.45 | 72.2 | — |
| Comp. Ex. 7 | FIG. 1 | 1 | — | 752 | 4.35 | 4.45 | 23.0 | — |
| Ex. 7 | FIG. 1 | 1 | 3 | 752 | 4.30 | 4.40 | 83.9 | — |
| Comp. Ex. 8 | FIG. 1 | 1 | 3 | 752 | 4.30 | 4.40 | 66.9 | — |
| Comp. Ex. 6 | FIG. 1 | 1 | 3 | 752 | 4.20 | 4.30 | 89.8 | — |
| Comp. Ex. 9 | FIG. 1 | 1 | 3 | 752 | 4.20 | 4.30 | 88.3 | — |
| Comp. Ex. 2 | FIG. 2 | 1 | — | 752 | 4.40 | 4.50 | 70.2 | Mechanofusion |
| Comp. Ex. 3 | FIG. 2 | 1 | 3 | 752 | 4.40 | 4.50 | 71.1 | Mechanofusion |
| Comp. Ex. 10 | FIG. 2 | 1 | — | 752 | 4.20 | 4.30 | 86.2 | Mechanofusion |
| Comp. Ex. 11 | FIG. 2 | 1 | 3 | 752 | 4.20 | 4.30 | 86.9 | Mechanofusion |

The results are as follows. Each of the non-aqueous electrolyte secondary batteries of Examples 2, 6, and 7 as well as Comparative Examples 1, 7, and 8 used the positive electrode in which the mixture of the conductive agent and the binder was interspersed between the positive electrode active material particles. Also, each of the batteries was designed to have an end-of-charge voltage of 4.30 V (which is equivalent to 4.40 V versus a lithium reference electrode potential [vs. Li/Li⁺]) or higher. When comparing the non-aqueous electrolyte secondary batteries of Examples 2, 6, and 7 with those of Comparative Examples 1, 7, and 8 having the same designed end-of-charge voltages, respectively, the non-aqueous electrolyte secondary batteries of Example 2, 6, and 7 exhibited significant improvements in the capacity retention rate after high temperature storage over those of Comparative Examples 1, 7, and 8. Note that Example 2, 6, and 7 used the non-aqueous electrolyte solution containing LiBF₄, while Comparative Examples 1, 7, and 8 used the non-aqueous electrolyte solution containing no LiBF₄.

As for the non-aqueous electrolyte secondary batteries of Comparative Examples 6 and 9, each of them used a positive electrode in which the mixture of the conductive agent and the binder was interspersed between the positive electrode active material particles. Also, each of them was designed to have an end-of-charge voltage of 4.20 V (which is equivalent to 4.30 V versus a lithium reference electrode potential [vs. Li/Li⁺]) or higher. It is seen that both the non-aqueous electrolyte secondary battery of Comparative Example 6, which used a non-aqueous electrolyte containing LiBF₄, and that of Comparative Example 9, which used a non-aqueous electrolyte containing no LiBF₄, had almost the same capacity retention rate after high temperature storage. This indicates that in Comparative Examples 6 and 9, the use of the non-aqueous electrolyte containing LiBF₄ did not yield the effect of improving the capacity retention rate after high temperature storage.

Each of the non-aqueous electrolyte secondary batteries of Comparative Examples 2, 3, 10, and 11 used a positive electrode in which the entire surface of each of the positive electrode active material particles was coated with a coating layer made of the mixture of conductive agent and the binder, formed by dry-blending the positive electrode active material and the conductive agent. The batteries of Comparative Examples 2, 3, 10, and 11 did not show significant improvements in capacity retention rate after high temperature storage when using the non-aqueous electrolyte solution containing LiBF₄ as described above.

It should be noted that the lower the designed end-of-charge voltage, the higher the capacity retention rate after storage in both the non-aqueous electrolyte secondary batteries using the positive electrode in which the mixture of conductive agent and the binder was interspersed between the positive electrode active material particles and the batteries using the positive electrode in which the surface of the positive electrode active material particles was coated with the conductive agent by dry-blending the positive electrode active material and the conductive agent. However, when the end-of-charge voltage was set low in designing a battery, the positive electrode active material could not be utilized sufficiently and a non-aqueous electrolyte secondary battery with a high capacity could not be obtained.

### Example 8

In Example 8, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1, except that the non-aqueous electrolyte solution contained LiBF₄ in an amount of 3.0 weight %, as in Example 2, and that the non-aqueous electrolyte solution further contained vinylene carbonate (VC) in an amount of 1.0 weight % as a surface-film forming agent for forming a surface film on the negative electrode.

### Comparative Example 12

In Comparative Example 12, a non-aqueous electrolyte secondary battery designed to have an end-of-charge voltage of 4.40 V (which is equivalent to 4.50 V versus a lithium reference electrode potential [vs. Li/Li⁺]) was fabricated in the same manner as described in Example 1, except that the non-aqueous electrolyte solution contained no LiBF₄, as in Comparative Example 1, and that the non-aqueous electrolyte solution contained vinylene carbonate (VC) in an amount of 1.0 weight % as a surface-film forming agent for forming a surface film on the negative electrode.

The capacity retention rate (%) after high temperature storage was obtained for each of the non-aqueous electrolyte secondary batteries of Example 8 and Comparative Example 12, in the same manner as in the cases of the non-aqueous electrolyte secondary batteries of Example 2 and Comparative Example 1 above. In addition, the initial charge-discharge efficiency (%) was obtained for each non-aqueous electrolyte secondary battery of Examples 2 and 8 as well as Comparative Examples 1 and 12 in the previously-described manner. The results are shown in Table 5 below.

TABLE 5

| | | Non-aqueous | | | | Designed | | | |
|---|---|---|---|---|---|---|---|---|---|
| | Positive | electrolyte | | | | end-of-charge | | Capacity | Initial |
| | electrode | LiPF₆ | LiBF₄ | VC | Separator | voltage | | retention rate | charge-discharge |
| | condition | (mol/L) | (wt. %) | (wt. %) | x · y (μm · %) | (V) | (V vs. Li/Li⁺) | after storage (%) | efficiency (%) |
| Ex. 2 | FIG. 1 | 1 | 3 | — | 752 | 4.40 | 4.50 | 72.0 | 91.6 |
| Ex. 8 | FIG. 1 | 1 | 3 | 1 | 752 | 4.40 | 4.50 | 73.5 | 92.4 |
| Comp. | FIG. 1 | 1 | — | — | 752 | 4.40 | 4.50 | 16.4 | 92.7 |
| Ex. 1 | | | | | | | | | |
| Comp. | FIG. 1 | 1 | — | 1 | 752 | 4.40 | 4.50 | 16.8 | 92.2 |
| Ex. | | | | | | | | | |
| 12 | | | | | | | | | |

The results demonstrate that the non-aqueous electrolyte secondary battery of Example 8, which employed the non-aqueous electrolyte solution containing LiBF₄ in an amount of 3.0 weight % and further containing vinylene carbonate (VC) for forming a surface film on the negative electrode in an amount of 1.0 weight %, exhibited a higher capacity retention rate after high temperature storage and a higher initial charge-discharge efficiency than the battery of Example 2, which contained no vinylene carbonate (VC) for forming a surface film on the negative electrode. This is believed to be because a surface film was formed on the negative electrode surface due to vinylene carbonate (VC) and the surface film inhibited LiBF₄ from being decomposed on the negative electrode surface.

As for the non-aqueous electrolyte secondary batteries of Comparative Examples 1 and 12, each of which used the non-aqueous electrolyte solution containing no LiBF₄, little variation in the capacity retention rate after high temperature storage and in the initial charge-discharge efficiency was observed between the battery using the non-aqueous electrolyte solution containing vinylene carbonate (VC) for forming a surface film on the negative electrode and the battery using the non-aqueous electrolyte solution containing no vinylene carbonate (VC), so the advantageous effect resulting from the addition of vinylene carbonate (VC) for forming a surface film on the negative electrode to the non-aqueous electrolyte solution was not obtained.

### Examples 9 and 10

In Examples 9 and 10, non-aqueous electrolyte secondary batteries designed to have an end-of-charge voltage of 4.40 V (which is equivalent to a lithium reference electrode potential [vs. Li/Li⁺] of 4.50 V) were fabricated in the same manner as described in Example 1 above, except that the non-aqueous electrolyte solution contained LiPF₆ at a concentration of 1 mol/L and LiBF₄ in an amount of 3.0 weight %, as in Example 2 above, and that the separator was varied from the one used in Example 1 above.

In Example 9, the separator used was a microporous polypropylene film having a thickness x of 12 μm, a porosity y of 38%, and a pore volume x·y of 456 μm-%. In Example 10, the separator used was a microporous polypropylene film having a thickness x of 23 μm, a porosity y of 48%, and a pore volume x·y of 1,104 μm·%.

### Comparative Examples 13 to 16

In Comparative Examples 13 to 16, non-aqueous electrolyte secondary batteries designed to have an end-of-charge voltage of 4.40 V (which is equivalent to 4.50 V versus a lithium reference electrode potential [vs. Li/Li⁺]) were fabricated in the same manner as described in Example 1, except that the non-aqueous electrolyte solution contained no LiBF₄, as in Comparative Example 1, and that the separator was varied from the one used in Example 1 above.

In Comparative Example 13, the separator used was a microporous polypropylene film having a thickness x of 12 μm, a porosity y of 38%, and a pore volume x·y of 456 μm·%. In Comparative Example 14, the separator used was a microporous polypropylene film having a thickness x of 18 μm, a porosity y of 45%, and a pore volume x·y of 810 μm-%. In Comparative Example 15, the separator used was a microporous polypropylene film having a thickness x of 23 μm, a porosity y of 48%, and a pore volume x·y of 1,104 μm·%. In Comparative Example 16, the separator used was a microporous polypropylene film having a thickness x of 27 μm, a porosity y of 52%, and a pore volume x·y of 1,404 μm·%.

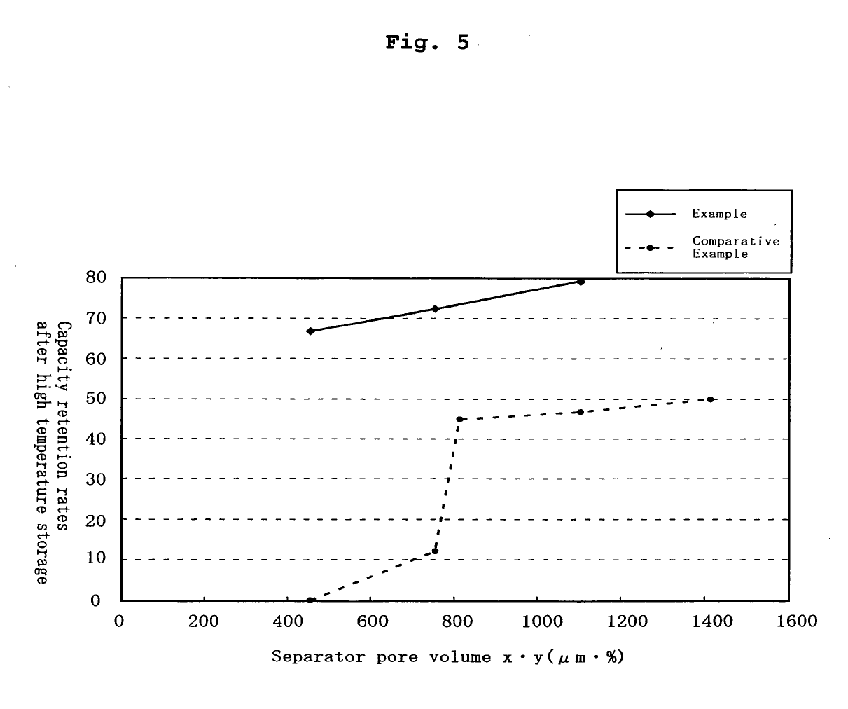

The capacity retention rate (%) after high temperature storage was obtained for each of the non-aqueous electrolyte secondary batteries of Examples 9 and 10 as well as Comparative Examples 13 to 16 in the same manner as in the cases of the non-aqueous electrolyte secondary batteries of Example 2 and Comparative Example 1 above. The results are shown in Table 6 below and FIG. 5.

TABLE 6

| | | Non- | | | | | |
|---|---|---|---|---|---|---|---|
| | | aqueous | | | Designed | | |
| | | electrolyte | | Sepa- | end-of- | | Capacity |
| | | solution | | rator | charge | | retention |
| | Positive | LiPF₆ | | x · y | voltage | | rate after |
| | electrode | (mol/ | LiBF₄ | (μm · | | (V vs. | storage |
| | condition | L) | (wt. %) | %) | (V) | Li/Li⁺) | (%) |
| Ex. 9 | FIG. 1 | 1 | 3 | 456 | 4.40 | 4.50 | 67.2 |
| Ex. 2 | FIG. 1 | 1 | 3 | 752 | 4.40 | 4.50 | 72.0 |
| Ex. 10 | FIG. 1 | 1 | 3 | 1104 | 4.40 | 4.50 | 79.3 |
| Comp. | FIG. 1 | 1 | — | 456 | 4.40 | 4.50 | 0.1 |
| Ex. 13 | | | | | | | |
| Comp. | FIG. 1 | 1 | — | 752 | 4.40 | 4.50 | 16.4 |
| Ex. 1 | | | | | | | |
| Comp. | FIG. 1 | 1 | — | 810 | 4.40 | 4.50 | 45.0 |
| Ex. 14 | | | | | | | |
| Comp. | FIG. 1 | 1 | — | 1104 | 4.40 | 4.50 | 47.3 |
| Ex. 15 | | | | | | | |
| Comp. | FIG. 1 | 1 | — | 1404 | 4.40 | 4.50 | 50.2 |
| Ex. 16 | | | | | | | |

The results demonstrate that in the non-aqueous electrolyte secondary batteries of Comparative Examples 1 and 13 to 16, which used the non-aqueous electrolyte solution containing no LiBF₄, the capacity retention rates after high temperature storage evidently dropped when the separator pore volume x·y was 800 μm·% or below.

In contrast, the non-aqueous electrolyte secondary batteries of Examples 2, 9, and 10, which employed the non-aqueous electrolyte solution containing LiBF₄, showed little variations in the capacity retention rate after high temperature storage even when the separator pore volume x·y was 800 μm·% or below, and they were capable of high capacity retention rate after storage.

This indicates that the non-aqueous electrolyte secondary batteries of the examples, which employ the non-aqueous electrolyte solution containing LiBF₄, can achieve high capacity retention rate after high temperature storage even when the separator thickness is made small to increase the capacity density of the battery.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

This application claims priority of Japanese patent application No. 2006-220799 filed Aug. 14, 2006, which is incorporated herein by reference.

What is claimed is:

1. A non-aqueous electrolyte secondary battery comprising:
a positive electrode containing a positive electrode active material, a conductive agent, and a binder, the positive electrode active material comprising positive electrode active material particles, the surface of each particle not entirely coated with the conductive agent, and the positive electrode having an end-of-charge voltage of 4.40 V or higher versus a lithium reference electrode potential;
a negative electrode;
a separator satisfying the condition x·y≦1500 (μm·%), where x is the thickness (μm) of the separator and y is the porosity (%) of the separator; and
a non-aqueous electrolyte solution containing LiBF₄.

2. The non-aqueous electrolyte secondary battery according to claim 1, wherein the positive electrode is prepared by wet-blending the positive electrode active material and the conductive agent.

3. The non-aqueous electrolyte secondary battery according to claim 1, wherein LiBF₄ is added in an amount of from 0.1 weight % to 5.0 weight % to the non-aqueous electrolyte solution.

4. The non-aqueous electrolyte secondary battery according to claim 1, wherein the non-aqueous electrolyte contains LiPF₆ at a concentration of 0.6 mol/L to 2.0 mol/L.

5. The non-aqueous electrolyte secondary battery according to claim 3, wherein the non-aqueous electrolyte contains LiPF₆ at a concentration of 0.6 mol/L to 2.0 mol/L.

6. The non-aqueous electrolyte secondary battery according to claim 1, wherein the positive electrode active material comprises a lithium cobalt oxide that contains aluminum (Al) and/or magnesium (Mg) in the form of a solid solution and zirconium (Zr) adhering on the surface thereof.

7. The non-aqueous electrolyte secondary battery according to claim 3, wherein the positive electrode active material comprises a lithium cobalt oxide that contains aluminum (Al) and/or magnesium (Mg) in the form of a solid solution and zirconium (Zr) adhering on the surface thereof.

8. The non-aqueous electrolyte secondary battery according to claim 4, wherein the positive electrode active material comprises a lithium cobalt oxide that contains aluminum (Al) and/or magnesium (Mg) in the form of a solid solution and zirconium (Zr) adhering on the surface thereof.

9. The non-aqueous electrolyte secondary battery according to claim 5, wherein the positive electrode active material comprises a lithium cobalt oxide that contains aluminum (Al) and/or magnesium (Mg) in the form of a solid solution and zirconium (Zr) adhering on the surface thereof.

10. The non-aqueous electrolyte secondary battery according to claim 1, wherein the positive electrode has an end-of-charge voltage of 4.45 V or higher versus a lithium reference electrode potential.

11. The non-aqueous electrolyte secondary battery according to claim 3, wherein the positive electrode has an end-of-charge, voltage of 4.45 V or higher versus a lithium reference electrode potential.

12. The non-aqueous electrolyte secondary battery according to claim 9, wherein the positive electrode has an end-of-charge voltage of 4.45 V or higher versus a lithium reference electrode potential.

13. The non-aqueous electrolyte secondary battery according to claim 1, wherein the separator satisfies the condition x·y≦800 (μm·%).

14. The non-aqueous electrolyte secondary battery according to claim 3, wherein the separator satisfies the condition x·y≦800 (μm·%).

15. The non-aqueous electrolyte secondary battery according to claim 12, wherein the separator satisfies the condition x·y≦800 (μm·%).

16. The non-aqueous electrolyte secondary battery according to claim 1, wherein the non-aqueous electrolyte solution contains a surface-film forming agent for forming a surface film on the negative electrode.

17. The non-aqueous electrolyte secondary battery according to claim 13, wherein the non-aqueous electrolyte solution contains a surface-film forming agent for forming a surface film on the negative electrode.

18. The non-aqueous electrolyte secondary battery according to claim 16, wherein the surface-film forming agent is vinylene carbonate.

19. The non-aqueous electrolyte secondary battery according to claim 16, wherein the surface-film forming agent is added in an amount of from 0.1 weight % to 5.0 weight % to the non-aqueous electrolyte solution.

20. The non-aqueous electrolyte secondary battery according to claim 18, wherein the surface-film forming agent is added in an amount of from 0.1 weight % to 5.0 weight % to the non-aqueous electrolyte solution.
